(19) United States
(12) Patent Application Publication
(10) Pub. No.: US 2020/0002474 A1
(43) Pub. Date: Jan. 2, 2020

(54) PROCESSES FOR REMOVING RESIDUAL CAPROLACTAM VIA SSP WATER ADDITION

(71) Applicant: Ascend Performance Materials Operations LLC, Houston, TX (US)

(72) Inventors: Michael K. Goodin, Pensacola, FL (US); Chris Schwier, Pensacola, FL (US); John J. Tria, JR., Cantonment, FL (US)

(73) Assignee: Ascend Performance Materials Operations LLC, Houston, TX (US)

(21) Appl. No.: 16/455,344

(22) Filed: Jun. 27, 2019

Related U.S. Application Data
(60) Provisional application No. 62/690,748, filed on Jun. 27, 2018.

(51) Int. Cl. C08G 69/06; C08G 69/14

(52) U.S. Cl. CPC C08G 69/06; C08G 69/14

(57) ABSTRACT

The present disclosure relates to processes for producing high molecular weight polyamides from caprolactam. In particular, the present disclosure relates to processes for adding water during Solid State Polymerization (SSP) to remove residual caprolactam to form high molecular weight polyamides, e.g., Nylon 6 and Nylon 6,6 copolymers, having low residual caprolactam monomer content. The water addition step controls the SSP process for a specific time to produce polyamides with a desired molecular weight and low residual caprolactam monomer content.

### CROSS-REFERENCE TO RELATED APPLICATION

This application claims the benefit of and the priority to U.S. Provisional Application No. 62/690,748, filed on Jun. 27, 2018, which is hereby incorporated by reference in its entirety for all purposes.

### FIELD

The present disclosure generally relates to processes for producing high molecular weight polyamides comprising caprolactam monomers. In particular, the present disclosure relates to processes for removing residual caprolactam by adding water during Solid State Polymerization (SSP) to form high molecular weight polyamides having low residual caprolactam content.

### BACKGROUND

Polyamides formed using caprolactam, e.g., ε-caprolactam, (“caprolactam”) are used in various applications, e.g., film formation, extrusion, molding, and food packaging films, because of their advantageous properties. For example, these polyamides have low crystallinity and lower melting points as well as high drawability and clarity, which make them particularly suitable for various film and extrusion applications.

In some cases, however, all of the caprolactam monomers used for the polymerization reaction may not entirely polymerize into high molecular weight polyamides, and the resultant crude polymer product may contain residual low molecular weight caprolactam-containing components, e.g., caprolactam monomers and oligomers. In conventional processes, these low molecular components are often removed by extraction with hot water. The monomeric caprolactam in the extraction water can be purified and cleaned to recapture caprolactam, which can be recycled to the polymerization reactor. It is also possible to react the oligomers obtained in the extraction water back into caprolactam monomers by adding splitting reagents then isolating and washing to yield the monomers, which may then be reused.

U.S. Pat. No. 4,053,457 discloses a process for the manufacture of polyamides from ε-caprolactam and/or other polyamide-forming starting compounds by polymerization and subsequent extraction of the polymer. The extract containing solvent, monomer, and oligomers is concentrated in the absence of atmospheric oxygen. The surfaces that come into contact with the extract are made of materials that are inert under the conditions of the concentration process. The resultant concentrate, without further purification or separation, is polymerized by itself or together with other polyamide-forming starting compounds.

Additionally, it is desirable for caprolactam-containing polyamides to have high molecular weights, e.g., to aid in efficient processing and/or in the achievement of the properties mentioned above. Commonly, to form high molecular weight polyamides, a subsequent solid state polymerization (SSP) step may be employed after the polymer is first polymerized and washed. For example, U.S. Pat. No. 6,069,228 discloses a process for preparing polyamide polymers via prepolymer formation in a reactor system comprising a reactor, flasher and separator, crystallization of the prepolymer under controlled temperature conditions and the subsequent conversion of these crystallized prepolymers to high molecular weight polymer via SSP.

In the aforementioned processes, polymers are produced with high residual caprolactam levels. In these cases, it is economic to recover the residual monomer and recycle the recovered monomers back to the polymerization reactor. For polymers with low residual caprolactam levels, it would be prohibitively expensive to install the extensive equipment required for the recovering such a low level of caprolactam monomer for recycle to the polymerization process.

Even in view of the references, the need exists for improved control and removal of residual caprolactam during solid state polymerization while achieving the desired molecular weight levels in the resultant polyamide. Additionally, there exists a need for an improved process for preparing high-molecular weight polymers with lower residual caprolactam levels.

### SUMMARY

In some embodiments, the present disclosure is related to a process for producing polyamides having a low residual caprolactam content, comprising: (a) supplying a polyamide feedstock comprising caprolactam monomers to a solid state polymerization reactor; (b) initiating polymerization of the polyamide feedstock in the solid state polymerization reactor; and (c) adding water to the solid state polymerization reactor during polymerization to yield a high molecular weight polyamide solution comprising less than 0.6 wt % of residual caprolactam. In some aspects, step (c) comprises adding a steam sweep gas to the solid state polymerization reactor. The steam sweep gas can be added to the polymerization reactor under vacuum. In some aspects, the steam sweep gas is added in combination with an inert sweep gas. In some aspects, the high molecular weight polyamide solution comprises polyamides having a relative viscosity ranging from 60 to 300. In some aspects, the high molecular weight polyamide solution comprises polyamides having a relative viscosity equal to or less than 130. In some aspects, the polyamide feedstock undergoes polymerization in the sold state polymerization reactor for less than 12 hours, wherein the high molecular weight polyamide solution comprises less than 0.6 wt % of residual caprolactam, and wherein the high molecular weight polyamide solution comprises polyamides having a relative viscosity ranging from 60 to 300. In some aspects, step (c) comprises adding a steam sweep gas to the solid state polymerization reactor, wherein the high molecular weight polyamide solution comprises less than 0.2 wt % of residual caprolactam, and wherein the high molecular weight polyamide solution comprises polyamides having a relative viscosity equal to or less than 130. In some aspects, the polyamide feedstock comprises polymer pellets comprising water. The polymer pellets may comprise less than 25 wt % of water. In some aspects, step (c) comprises releasing steam from the polymer pellets during polymerization in the solid state polymerization reactor.

In some embodiments, the present disclosure is related to a process for producing polyamides having a low residual caprolactam content, comprising: (a) supplying a polyamide feedstock comprising caprolactam monomers to a solid state polymerization reactor; (b) polymerizing the polyamide feedstock in the solid state polymerization reactor; and (c) adding a steam sweep gas to the solid state polymerization reactor during polymerization to yield a high molecular weight polyamide solution comprising less than 0.6 wt % of residual caprolactam. In some aspects, a ratio of the flow rate of steam in grams per hour to the weight of the polymer pellets in grams ranges from 0.08:1 to 20:1. In some aspects, the polyamide feedstock undergoes polymerization in the solid state polymerization reactor for less than 12 hours, wherein the high molecular weight polyamide solution comprises less than 0.6 wt % of residual caprolactam, and wherein the high molecular weight polyamide solution comprises polyamides having a relative viscosity ranging from 60 to 300. In some aspects, the steam sweep has is added to the polymerization reactor under vacuum when polymerization is initiated.

In some embodiments, the present disclosure is related to a process for producing polyamides having a low residual caprolactam content, comprising: (a) supplying a polyamide feedstock comprising caprolactam monomers to a solid state polymerization reactor, wherein the polyamide feedstock comprises polymer pellets comprising water; polymerizing the polyamide feedstock in the solid state polymerization reactor; and (c) releasing water from the polymer pellets during polymerization in the solid state polymerization reactor to yield a high molecular weight polyamide solution comprising less than 0.6 wt % of residual caprolactam. In some aspects, the polymer pellets comprise less than 25 wt % of water. In some aspects, the polymer pellets are preconditioned with water. In some aspects, the polymer pellets release water into the solid state polymerization reactor at controlled rate.

### BRIEF DESCRIPTION OF THE DRAWINGS

FIG. 1 shows a graph of the amount of residual caprolactam in a polyamide solution over time in SSP processes according to embodiments of the present disclosure.

FIG. 2 shows a graph of relative viscosity of polyamides formed over time in SSP processes according to embodiments of the present disclosure.

### DETAILED DESCRIPTION

The present disclosure is directed to processes for removing residual caprolactam monomers during Solid State Polymerization (SSP) to form high molecular weight polyamides, e.g., copolyamides, having low (residual) caprolactam content. In some aspects, the present process simultaneously removes residual caprolactam, e.g., monomers and/or oligomers, and achieves high molecular weight polyamides. The processes beneficially eliminate the water washing step, thereby improving process efficiency, decreasing costs, and preventing polymer degradation. Also, by eliminating the water washing step, the SSP process can be controlled, e.g., for a specific time, to produce polymers with a desired molecular weight. The resulting caprolactam containing polyamide is useful for a variety of applications, e.g., films, extrusion profiles, and fibers.

In some embodiments, the present disclosure is directed to processes for removing residual caprolactam monomers during SSP to form a high molecular weight polyamide solution. The process can include introducing water, e.g., steam, into the SSP process to reduce caprolactam monomer content while maintaining the SSP process for a sufficient time to achieve the desired molecular weight to form high molecular weight polyamides. The high molecular weight polyamides formed from the process have low residual caprolactam content and a desired molecular weight (as measured by relative viscosity). In some aspects, the relative viscosity (RV) of the high molecular weight polyamides ranges from about 60 to about 300 and the residual caprolactam concentration is less than 0.6 wt %. The process produces a customizable uniform polyamide having minimal to substantially no residual caprolactam monomer content.

As used herein, “polyamides” refer to linear condensation polymers comprising the amide group (—NHCO—) repeating in the polymer backbone, and “copolyamides” refer to compositions including multiple polyamide forming monomer combinations. Exemplary polyamides and polyamide compositions are described in Kirk-Othmer, Encyclopedia of Chemical Technology, Vol. 18, pp. 328-371 (Wiley 1982), the disclosure of which is incorporated by reference.

Briefly, polyamides are products that contain recurring amide groups as integral parts of the main polymer chains. Linear polyamides are of particular interest and may be formed from condensation of bifunctional monomers as is well known in the art. Polyamides are frequently referred to as nylons. Particular polymers and copolymers and their preparation are seen in the following patents: U.S. Pat. No. 4,760,129, entitled “Process for Preparing Highly Viscous Polyhexamethyleneadipamide”, to Haering et al.; U.S. Pat. No. 5,504,185, entitled “Process for Production of Polyamides, Polyamides Produced by Said Process and Polyamide Film or Sheet”, to Toki et al.; U.S. Pat. No. 5,543,495, entitled “Process for Increasing the Molecular Weight of Polyamides and Other Condensation Polymers”, to Anolick et al.; U.S. Pat. No. 5,698,658, entitled “Linear Very High Molecular Weight Polyamides and Process for Producing Them”, to Dujari et al.; U.S. Pat. No. 6,011,134, entitled “Method for Manufacturing Poly(Hexamethylene Adipamide) from Monomethyladipate and Hexamethylenediamine”, to Marks et al.; U.S. Pat. No. 6,136,947, entitled “Process and Device for the Standardized Continuous Production of Polyamides”, to Wiltzer et al.; U.S. Pat. No. 6,169,162, entitled “Continuous Polyamidation Process”, to Bush et al.; “Polyamide Chain Extension Process and Related Polyamide Product”, to Zahr; U.S. Pat. No. 7,138,482, entitled “Production Method of Polyamide”, to Tanaka.; U.S. Pat. No. 7,381,788, entitled “Method for Continuous Production of Polyamide”, to Tsujii et al.; and U.S. Pat. No. 8,759,475, entitled “Continuous Production of Polyamides”, to Thierry et al.

Percentages, parts per million (ppm) and the like refer to weight percent or parts by weight based on the weight of the composition unless otherwise indicated.

Process temperatures refer to SSP set points unless otherwise indicated.

As noted above, in conventional processes, the polymers created by polymerizing caprolactam monomers typically include undesirable, low molecular weight components. These low molecular weight compounds form as by-products, or unreacted monomers, of the polymerization reaction, which have a detrimental effect on the properties of the polyamides and are therefore normally removed. For example, the low-molecular weight compounds may detrimentally affect products, e.g., injection-molded products, by diffusing on the surface thereof, thus forming a greasy film. These diffused low molecular weight compounds may also impair the surface appearance of the products, e.g., reduced gloss and impaired color impression. Still further, the residual caprolactam can detrimentally result in: (1) build up/plate out on process equipment surfaces leading to downtime or reduced production throughput; (2) a non-food contact compliant product according to regulatory specifications, e.g., FDA food contact compliance; and (3) interference with adhesion between film layers.

To avoid these problems, the low-molecular compounds are often removed, e.g., by extraction. Extraction is normally carried out with hot water or with liquids that contain mostly water. From these extraction waters, the residual caprolactam can be recaptured, cleaned, and in some cases, reintroduced as a recycle stream to the polymerization process. These separate steps, however, add equipment and operating costs and can add color to the resin.

An alternative process to water extraction is to remove the residual caprolactam as part of the SSP process. In this process, the caprolactam is volatilized at SSP temperatures and removed from the reactor. But the volatility of caprolactam is low, and using the SSP process step requires more time for SSP. And if longer times are needed for caprolactam removal in the SSP process, the resultant molecular weight of the polymer product, e.g., nylon, may be outside of the desired range, e.g., higher than desired. Conversely, if the time of the SSP process is set to achieve the desired molecular weight, there may be insufficient time for adequate caprolactam removal and the residual caprolactam monomer and/or oligomer content will be high.

The inventors have now found that adding water during SSP can beneficially produce polyamides having both a desired molecular weight with low residual caprolactam content. It was found that adding water during SSP (at some time during polymerization of the polyamide feedstock) helps remove residual caprolactam and forms high molecular weight polyamides, e.g., Nylon 6 and Nylon 6,6 copolymers, having low residual caprolactam monomer content and the desired relative viscosity (e.g., relative viscosity as measure of molecular weight). Without being bound be theory, it is believed that the addition of water slows down molecular weight building of the polyamide and provides sufficient time for removing residual caprolactam. The water addition step controls the SSP process for a specific time (e.g., less time) to produce polymers with a desired molecular weight and low residual caprolactam monomer content.

In some cases, the addition of water can be employed to suppress the forward polymerization process and limit molecular weight building to a desired RV. It has been discovered that residual caprolactam monomer is volatile at the temperature of SSP process. As such, the residual caprolactam can be volatilized and removed during the SSP process. By introducing water into a SSP reactor, the inventors have advantageously moderated the molecular weight building process to enable efficient caprolactam monomer removal. Without being bound by theory, it is believed that since caprolactam is highly water-soluble, the volatilized caprolactam preferentially leaves with water compared to a dry vapor stream, e.g., nitrogen sweep or vacuum.

In some embodiments, the residual caprolactam monomer is volatile at the temperature of SSP process ranging from 140° C. to 240° C., e.g., from 150° C. to 230° C., from 160° C. to 220° C., from 165° C. to 215° C., from 170° C. to 210° C., from 175° C. to 205° C., from 180° C. to 200° C., or from 185° C. to 195° C. In terms of upper limits, the residual caprolactam monomer is volatile at a temperature of SSP of less than 240° C., e.g., less than 230° C., less than 225° C., less than 220° C., less than 210° C., less than 200° C., or less than 190° C. In terms of lower limits, the residual caprolactam monomer is volatile at a temperature of SSP greater than 140° C., e.g., greater than 145° C., greater than 150° C., greater than 160° C., greater than 165° C., greater than 170° C., greater than 175° C., greater than 180° C., or greater than 185° C.

Advantageously, the removal of residual caprolactam from the polyamide has been found to retard the propensity for plate-out of the residual caprolactam monomer on metal surfaces. Plate-out typically occurs when the residual caprolactam monomer volatilizes from the polymer melt at high processing temperatures and then condenses on metal surfaces of the processing equipment. This plate-out, generates harmful flaws and defects in the films and/or other end products. The reduction or elimination of residual caprolactam in the polyamide beneficially leads to reduction or elimination of plate-out. The processes also beneficially produce polyamides that comply with FDA regulation (21 CFR 177.1500 (b) (4.1)), which requires low amounts of residual caprolactam for food contact applications.

Additionally, the process prevents residual caprolactam from blooming to the film surface which can cause various problems such as reduced adhesion with other polymer film layers, e.g., maleated polyethylene, poly(ethylene vinyl alcohol), and creates haze which limits film clarity.

The manner of the addition of water into the SSP process may vary widely, as long as the water is provided as noted herein. In some aspects, water is added to the SSP reactor in a sweep gas. The term “sweep gas” may refer to a gas stream passed through the head space of the reactor during polymerization. The sweep gas sweeps reactor vapor, e.g., volatilized reaction components such as residual caprolactam, out of the reactor. As noted above, caprolactam volatilizes at SSP conditions. In operation, the steam sweep gas is fed to an inlet the SSP reactor, e.g., at SSP conditions, at a first end of the reactor. The sweep gas then proceeds through the reactor to sweep the volatilized components and exits via an outlet at an opposite end of the reactor. In some embodiments, a vacuum can be used in addition to the steam sweep gas to facilitate removal of the volatilized components. The steam sweep gas beneficially removes residual caprolactam and can suppress the forward polymerization process, e.g., by lowering temperature, and limit molecular weight building to a desired RV.

In some aspects, the SSP process can be operated at atmospheric pressure with a steam sweep gas. In some aspects, the SSP process can be operated under vacuum conditions to facilitate movement of the sweep gas. In some aspects, a steam sweep can be added to a SSP reactor under low vacuum or high vacuum. In some embodiments, the steam sweep gas operates in a co-current manner. In other embodiments, the steam sweep gas operates in a counter-current manner. The present process can utilize any of the standard SSP operating configurations.

In some embodiments, when the SSP is conducted under vacuum, a small amount of inert gas, e.g., nitrogen, can be bled into the SSP reactor. The nitrogen gas, under vacuum conditions, is swept out of the reactor and may carry out other volatile species. In this case, the nitrogen gas can also be referred to as a sweep gas. The sweep gas is typically added at a location in the SSP reactor as far as possible from the location where vacuum is applied to the SSP reactor.

In some aspects, the steam sweep gas can be introduced to a SSP reactor in combination with an inert sweep gas. In some aspects, a steam sweep can be added to a SSP reactor under vacuum or under a combined operation, e.g., under vacuum with an inert sweep gas.

In some embodiments, steam or water (e.g., from polymer pellets) can be added to the SSP reactor when the polymer begins to build molecular weight during SSP. In some embodiments, the polymer begins to build molecular weight at a temperature greater than 120° C., e.g., greater than 125° C., greater than 130° C., greater than 135° C., greater than 140° C., or greater than 150° C. Steam or water can be added either continuously during the entire SSP cycle or added at the beginning to remove the caprolactam and then discontinued for the remainder of the SSP cycle when the final molecular weight is achieved.

In some aspects, SSP process can introduce water into the process by using polymer pellets having the desired water content incorporated in the polymer pellets. At SSP temperatures, water is boiled out of the polymer pellets and effectively adds water and/or steam, e.g., releases steam, to the SSP reactor. In some embodiments, the polymer pellets may allow for controlled release of water into the reactor. For example, the polymer pellets may include sub-capsules for controlled release of specific amounts of water at different time intervals or at different temperatures. In some embodiments, at least half the volume of water in the polymer pellets is released into the SSP reactor at 6 hours. In some embodiments, a portion of water in the polymer pellets is released into the SSP reactor at intervals of one hour. In some embodiments, a portion of water in the polymer pellets is released into the SSP reactor at intervals temperature in the reactor.

In some aspects, the polymer pellets can be pre-conditioned with water prior to charging the SSP reactor, e.g., SSP dryer. In some aspects, the polymer pellets can be charged to the SSP dryer and liquid water can be added to the vessel thereby allowing the water to be absorbed by the pellets in the SSP reactor. Advantageously, this process is compact, simple, and does not require a separate water washing step in addition to the conventional SSP process, thereby improving efficiency of the process. In some aspects, water can be introduced in the SSP reactor in liquid form (e.g., via a water stream) and can be boiled in the SSP reactor to provide steam.

In some embodiments, the polymer pellets may comprise water ranging from 0.5 wt % to 50 wt %, e.g., from 1 wt % to 45 wt %, from 2 wt % to 40 wt %, from 4 wt % to 35 wt %, from 5 wt % to 30 wt %, from 8 wt % to 25 wt %, from 10 wt % to 20 wt %, or from 12 wt % to 15 wt %. In terms of upper limits, the polymer pellets may comprise less than 50 wt % water, e.g., less than 40 wt %, less than 30 wt %, less than 25 wt %, less than 20 wt %, or less than 15 wt %. In terms of lower limits, the polymer pellets may comprise greater than 0.5 wt % water, e.g., greater than 1 wt %, greater than 2 wt %, greater than 4 wt %, greater than 5 wt %, greater than 6 wt %, or greater than 8 wt %.

In some embodiments, the high molecular weight polyamide solution produced after SSP has a (residual) caprolactam content ranging from 0.01 wt % to 0.6 wt %, e.g. from 0.02 wt % to 0.5 wt %, from 0.05 wt % to 0.4 wt %, from 0.1 wt % to 0.3 wt %, or from 0.15 wt % to 0.25 wt %. In terms of upper limits, the high molecular weight polyamide solution has a (residual) caprolactam content less than 0.6 wt %, e.g., less than 0.55 wt %, less than 0.5 wt %, less than 0.4 wt %, less than 0.3 wt %, less than 0.25 wt %, less than 0.2 wt %, or less 0.15 wt %. In terms of lower limits, the high molecular weight polyamide solution has a (residual) caprolactam greater than 0.01 wt %, e.g., greater than 0.02 wt %, greater than 0.04 wt %, greater than 0.05 wt %, greater than 0.06 wt %, greater than 0.07 wt %, greater than 0.08 wt %, or greater than 0.09 wt %. In some aspects, the high molecular weight polyamide solution has no (residual) caprolactam.

In some aspects, the water addition step slows down the SSP process to achieve polyamides with a desired molecular weight. In some cases, the molecular weight of the polyamides in the high molecular weight polyamide solution may be a function of relative viscosity (RV). In some embodiments, the polyamide has a RV ranging from 60 to 300, e.g., from 65 to 250, from 70 to 200, from 75 to 150, from 80 to 140, from 85 to 135, from 90 to 130, or from 95 to 120. In terms of lower limits, the polyamide has a RV greater than 60, e.g., greater than 65, greater than 70, greater than 75, greater than 80, or greater than 85. In terms of upper limits, the polyamide has a RV less than 300, e.g., less than 250, less than 200, less than 180, less than 160, less than 150, less than 140, less than 130, or less than 120.

In some embodiments, the high molecular weight polyamide solution has a viscosity number VN ranging from 100 mL/g to 250 mL/g, e.g., from 120 mL/g to 240 mL/g, from 140 mL/g to 220 mL/g, from 150 mL/g to 210 mL/g, from 160 mL/g to 200 mL/g, or from 170 mL/g to 190 mL/g. In terms of lower limits, the high molecular weight polyamide solution has a VN greater than 100 mL/g, e.g., greater than 105 mL/g, greater than 110 mL/g, greater than 120 mL/g, greater than 130 mL/g, or greater than 140 mL/g. In terms of upper limits, the high molecular weight polyamide has a VN less than 250 mL/g, e.g., less than 240 mL/g, less than 220 mL/g, less than 200 mL/g, less than 180 mL/g, or less than 160 mL/g.

In some embodiments, water, e.g., steam, is added to the SSP process to achieve a low content (residual) caprolactam content. In some embodiments, the ratio of the flow rate of steam (grams per hour) to the weight of the polymer pellets (grams) ranges from 0.01:1 to 100:1, e.g., from 0.02:1 to 80:1, from 0.04:1 to 60:1, from 0.06:1 to 40:1, from 0.08:1 to 20:1, from 0.1:1 to 10:1, from 0.5:1 to 5:1, from 0.8:1 to 2:1, or from 1:1 to 1.5:1. In terms of upper limits, the ratio of the flow rate of steam to the weight of the polymer pellets is less than 100:1, e.g., less than 90:1, less than 80:1, less than 60:1, less than 50:1, less than 40:1, less than 20:1, or less than 10:1. In terms of lower limits, the ratio of the flow rate of steam to the weight of the polymer pellets is greater than 0.01:1, e.g., greater than 0.02:1, greater than 0.08:1, greater than 0.1:1, greater than 0.5:1, or greater than 1:1.

In some aspects, to the processes achieve a beneficial combination of desired RV, a desired residual caprolactam content, and/or a desired molecular weight. In some aspects, water is added to the SSP process to increase the time for polymerization to enable sufficient residual caprolactam removal. In some aspects, the high molecular weight polyamide solution has a RV in the ranges and limits listed above and/or a caprolactam content in the ranges and limits listed above. In some aspects, the process achieves a high molecular weight polyamide solution having a caprolactam content of less than 0.2 wt % and a RV ranging from 80 to 150.

In some aspects, the formation of the polyamide feedstock introduced into the SSP reactor may vary, as long as caprolactam is employed as at least one of the monomers in forming the polyamide feedstock. For example, the polyamide feedstock may comprise a copolyamide comprising caprolactam to obtain a polymer mixture of polyamide, caprolactam, and oligomers of caprolactam. In some aspects, caprolactam and higher lactams up to 12 ring members or mixtures thereof are suitable. In some embodiments, the polyamide feedstock is introduced to the SSP reactor as polymer pellets.

In some embodiments, the polyamide feedstock may comprise PA-6, PA-6,6, PA4,6, PA-6,9, PA-6,10, PA-6,12, PA11, PA12, PA9,10, PA9,12, PA9,13, PA9,14, PA9,15, PA-6,16, PA9,36, PA10,10, PA10,12, PA10,13, PA10,14, PA12,10, PA12,12, PA12,13, PA12,14, PA-6,14, PA-6,13, PA-6,15, PA-6,16, PA-6,13, PAMXD,6, PA4T, PAST, PA-6T, PA9T, PA10T, PA12T, PA4I, PA5I, PA-6I, PA10I, copolymers, terpolymers, and mixtures thereof.

In some aspects, the polyamide feedstock may comprise polyamides produced through ring-opening polymerization or polycondensation, including the copolymerization and/or copolycondensation, of lactams. For example, these polyamides may include, for example, those produced from propriolactam, butyrolactam, valerolactam, laurolactam, caprolactam or combinations thereof. In some embodiments, the polyamide is a polymer derived from the polymerization of caprolactam. Furthermore, the polyamide composition may comprise the polyamides produced through the copolymerization of a lactam with a nylon, for example, the product of the copolymerization of a caprolactam with PA-6,6.

In some embodiments, the polyamide feedstock can be condensation products of one or more dicarboxylic acids, one or more diamines, one or more aminocarboxylic acids, and/or ring-opening polymerization products of one or more cyclic lactams, e.g., caprolactam and laurolactam. In some aspects, the polyamide feedstock may include aliphatic, aromatic, and/or semi-aromatic polyamides and can be homopolymer, copolymer, terpolymer or higher order polymers. In some aspects, the polyamide feedstock includes blends of two or more polyamides. In some embodiments, the polyamide feedstock comprises aliphatic or aromatic polyamides or blends of two or more polyamides.

In some aspects, the dicarboxylic acids may comprise one or more of adipic acid, azelaic acid, terephthalic acid, isophthalic acid, sebacic acid, and dodecanedioic acid. In some aspects, the dicarboxylic acids may comprise adipic, isophthalic and terephthalic acid. In some aspects, the dicarboxylic acids may comprise an aminocarboxylic acid, e.g., 11-aminododecanoic acid.

In some aspects, the diamines may comprise one or more of tetramethylenediamine, hexamethylenediamine, octamethylenediamine, nonamethylenediamine, 2-methylpentamethylenediamine, 2-methyloctamethylenediamine, trimethylhexamethylenediamine, bis(p-aminocyclohexyl)methane, m-xylylenediamine, p-xylylenediamine, decamethylenediamine, undecamethylenediamine, dodecamethylenediamine, tridecamethylenediamine, tetramethylenediamine, pentamethylenediamine, hexamethylenediamine, and the like. Other examples of the aromatic diamine components, which are merely illustrative, include benzene diamines such as 1,4-diaminobenzene, 1,3-diaminobenzene, and 1,2-diaminobenzene; diphenyl(thio)ether diamines such as 4,4′-diaminodiphenylether, 3,4′-diaminodiphenylether, 3,3′-diaminodiphenylether, and 4,4′-diaminodiphenylthioether; benzophenone diamines such as 3,3′-diaminobenzophenone and 4,4′-diaminobenzophenone; diphenylphosphine diamines such as 3,3′-diaminodiphenylphosphine and 4,4′-diaminodiphenylphosphine; diphenylalkylene diamines such as 3,3′-diaminodiphenylmethane, 4,4′-diaminodiphenylmethane, 3,3′-diaminodiphenylpropane, and 4,4′-diaminodiphenylpropane; diphenyl sulfide diamines such as 3,3′-diaminodiphenylsulfide and 4,4′-diaminodiphenylsulfide; diphenylsulfone diamines such as 3,3′-diaminodiphenylsulfone and 4,4′-diaminodiphenylsulfone; and benzidines such as benzidine and 3,3′-dimethylbenzidine.

In some aspects, the polyamide feedstock comprises physical blends of aliphatic polyamides, semiaromatic polyamides, and/or aromatic polyamides to obtain properties intermediate between or synergistic of the properties of each polyamide.

While much of the discussion above relates to polyamide feedstock, and in particular copolyamides of PA-6,6 and PA-6, the processes described herein can be applied to all polyamides ranging from aliphatic polyamides (traditionally PA-6,6 and PA-6 or other aliphatic nylons) to copolyamides with aromatic components (for example paraphenylenediamine and terephthalic acid), to copolymers such as adipate with 2-methyl pentmethylene diamine and 3,5-diacarboxybenzenesulfonic acid (or sulfoisophthalic acid in the form of its sodium sulfonate salt).

### Experimental Procedures

The following test methods may be employed to measure mechanical and chemical properties of the polymer and the drawn filaments.

Relative viscosity (RV) of nylons refers to the ratio of solution or solvent viscosities measured in a capillary viscometer at 25° C. as measured by ASTM D 789 (current year). The solvent is formic acid containing 10% by weight water and 90% by weight formic acid. The solution is 8.4% by weight polymer dissolved in the solvent.

The RV, (ηᵣ), is the ratio of the absolute viscosity of the polymer solution to that of the formic acid:

ηᵣ=(ηₚ/η_{f})=(ƒᵣ×dₚ×tₚ)/η_{f}
where: dₚ=density of formic acid-polymer solution at 25° C.,
tₚ=average efflux time for formic acid-polymer solution, s
η_{f}=absolute viscosity of formic acid, kPa×s(E+6cP)
ƒᵣ=viscometer tube factor, mm²/s (cSt)/s=ηᵣ/t₃

A typical calculation for a 50 RV specimen:

ηᵣ=(ƒᵣ×dₚ×tₚ)/η_{f}
where
ƒᵣ=viscometer tube factor, typically 0.485675 cSt/s
dₚ=density of the polymer—formic solution, typically 1.1900 g/ml
tₚ=average efflux time for polymer—formic solution, typically 135.00 s
η_{f}=absolute viscosity of formic acid, typically 1.56 cP
giving a RV of
ηᵣ=(0.485675 cSt/s×1.1900 g/ml×135.00 s)/1.56 cP=50.0

The term t₃ is the efflux time of the S-3 calibration oil used in the determination of the absolute viscosity of the formic acid as required in ASTM D 789 (current year).

Table 1 below provides an exemplary conversion chart for RV test methods. Table 1 compares the ASTM D 789 (current year) RV test method with other standard viscosity measurements.

TABLE 1

| ASTM D 789 | JIS K 6920-2 | ISO 307 |
|---|---|---|
| Formic Acid | Sulfuric Acid | Sulfuric Acid |
| (90%) | (98%) | (95.7%) |
| 40 | 2.5 | 2.4 |
| 45 | 2.7 | 2.5 |
| 50 | 2.8 | 2.7 |
| 55 | 2.9 | 2.8 |
| 60 | 3 | 2.9 |
| 65 | 3.1 | 3 |
| 70 | 3.2 | 3.1 |
| 75 | 3.3 | 3.1 |
| 80 | 3.4 | 3.2 |
| 85 | 3.5 | 3.3 |

Residual caprolactam was determined by dissolving 0.1 grams of nylon in a 3 mL solution comprising 90% of formic acid. The nylon was precipitated out of solution by adding 7 mL of a 10% methanol in water solution. The resulting solution was filtered through a 0.45 micron PTFE syringe filter into a High Pressure Liquid Chromatography (HPLC) vial. The HPLC conditions are as follows:
Mobile Phases: A) 10 mM methane sulfonic acid; and B) acetonitrile;
Gradient:

| Time (min) | % B |
|---|---|
| 0 | 1 |
| 10 | 99 |

Sample loop size: 10 μL
Column: Phenomenex Kinetex 5 μm EVO C18 100 Å HPLC column
Column Temperature: 50° C.
Detector: Diode Array Detector (DAD) set at 210 nm

These conditions produced the following HPLC chromatogram.

Calibration: Solutions with 59 ppm, 117 ppm, 228 ppm, 435 ppm and 587 ppm of caprolactam in methanol solution were used to calibrate the instrument. These standards produced the following caprolactam calibration curve.

### EXAMPLES

The following examples demonstrate that the process according to the present disclosure produces polyamides having a low content of residual caprolactam and a desired molecular weight (as measured by relative viscosity) compared to polyamides formed via conventional processes.

Comparative Examples A and B relate to polyamides formed using conventional technology/processes e.g., by polymerizing ε-caprolactam and/or other polyamide-forming starting compounds, extraction of the polymer with hot water, concentrating the aqueous extract containing water, monomer and oligomers, and solid state polymerization (SSP) of the aqueous extract to form a polyamide solution. The polyamide solutions of Comparative Examples A-C were produced via a process similar to commercial scale SSP process (without water addition nor water prior water washing). The examples were produced using a Thermogravimetric (TGA) instrument. The TGA was used to heat 70 mg of polyamide feedstock to 190° C. and then the feedstock was held for periods of 2, 4, and 6 hours. The TGA was purged with 50 sccm of Helium to effectively sweep out volatiles from the instrument.

Comparative Example A was produced under vacuum, while Comparative Example B was produced at atmospheric pressure. Table 2 shows the relative viscosity (RV) and caprolactam concentration of the polyamide solutions of Comparative Examples A and B at various times during the SSP process.

TABLE 2

| | Time | Temp | Capro | |
|---|---|---|---|---|
| Comp Ex | (hr) | (° C.) | (wt %) | RV |
| A | 2.5 | 125 | 1.59 | 36.4 |
| A | 3.75 | 162 | 1.306 | 39.9 |
| A | 4.75 | 169.5 | 1.036 | 46.9 |
| A | 5.75 | 176 | 0.924 | 59.9 |
| A | 6.75 | 181 | 0.705 | 78.1 |
| A | 7.75 | 176.5 | 0.549 | 111.5 |
| A | 8.75 | 179 | 0.531 | 133.5 |
| A | 9.75 | 178.5 | 0.416 | 163.5 |
| A | 10.8 | 178.5 | 0.392 | 171.8 |
| A | 11.8 | 178 | 0.333 | 201.5 |
| A | 12 | 45 | 0.269 | 242.7 |
| B | 0 | 190 | 1.74 | 43 |
| B | 2 | 190 | 0.59 | 81 |
| B | 4 | 190 | 0.34 | 125 |
| B | 6 | 190 | 0.22 | 365 |

As shown in Table 2, the polyamide solution of Comparative Example A reached a RV of greater than 100 before the amount of caprolactam was even below 0.6 wt %. Comparative Example A achieved either a desired RV or a low content of residual caprolactam, but not both. For example, at 6.75 hours SSP time, the process achieved a target RV of 78, however the residual caprolactam level was still very high at 0.705 wt %. At 12 hours SSP time, the residual caprolactam content decreased to 0.269 wt %, but the RV was very high at 242.7.

For Comparative Example B, again it can be seen that in a short time (2 hrs of SSP), the process achieved a polyamide solution having a RV of 81, but the residual caprolactam level was high at 0.59 wt %. At longer SSP times, the polyamide achieved a lower content of residual caprolactam, but the RV was very high.

### Comparative Example C:

The polyamide solution of Comparative Example C was produced in a SSP process at vacuum conditions with a nitrogen sweep gas. Table 3 shows the relative viscosity (RV) and wt % of caprolactam for Comparative Example C at different times during SSP with nitrogen addition.

TABLE 3

| | Time | Temp. | Pressure | N₂ | Capro | | VN |
|---|---|---|---|---|---|---|---|
| Example | (hr) | (° C.) | (torr) | (mL/min) | (wt %) | RV | (mL/g) |
| C | 0 | 25 | Vacuum | 0 | 1.63 | 30 | 102.5 |
| C | 3 | 190 | Vacuum | 50 | 0.62 | 69 | 161.3 |
| C | 6 | 190 | Vacuum | 50 | 0.3 | 133 | 220.8 |

As shown in Table 3, the addition of a nitrogen sweep during SSP reached a RV of 69 after 3 hours of SSP, but the amount of caprolactam was greater than 0.6 wt %. At 6 hours, the residual caprolactam content in the polyamide solution was lowered to 0.3 wt %, but the RV was 133. Although the nitrogen sweep performed better than Comparatives A and B, it still did not achieve a low content of residual caprolactam at an acceptable RV.

### Examples 1 and 2

The polyamides of Examples 1 and 2 were prepared via a SSP process with the addition of water (steam) to the reactor. A small scale laboratory sized SSP reactor was used in the process comprising a gas chromatogram oven (GC oven), copper tubing within the GC oven, and a vacuum pump. The GC oven included a 150 mL stainless steel gas bomb comprising the polyamide feedstock. About 20 lbs. of steam was feed into the GC oven through a needle valve which controlled the amount of steam entering the GC oven. The needle valve fed the steam into copper tubing which was connected to the gas bomb within the oven. The gas bomb exited through the copper tubing into a cold trap. Table 4 shows the RV and caprolactam content of the polyamide solution of Examples 1 and 2 at various times during SSP with the addition of a steam under vacuum conditions.

TABLE 4

| | Time | Temp. | Steam Flow | Capro | |
|---|---|---|---|---|---|
| Example | (hr) | (° C.) | (mL/min)* | (wt %) | RV |
| 1 | 3 | 190 | 4 | 0.4 | 53 |
| 1 | 6 | 190 | 5 | 0.18 | 72 |
| 2 | 3 | 190 | 0.6 | 0.41 | 57 |
| 2 | 6 | 190 | 0.2 | 0.2 | 94 |

*Steam flow as condensate collected in cold trap.

Table 4 shows that both low residual caprolactam level and a desirable RV were surprisingly achieved simultaneously, by utilizing water (steam) addition during the SSP process. For example, after 6 hours of SSP time for Example 1 (high steam flow), the polyamide solution had less than 0.2 wt % of residual caprolactam and a RV of 72. Additionally, after 6 hours of SSP time for Example 2 (low steam flow), the polyamide solution had 0.2 wt % of residual caprolactam and a RV of 94. Surprisingly, adding steam (regardless of the rate of steam flow) during the SSP process achieved low residual caprolactam and controlled the RV of the polyamide solution in an acceptable range.

### Examples 3-8

The polyamides of Examples 3-8 employed the process described above for Examples 1 and 2 with the addition of a steam sweep gas during the SSP process. The steam sweep gas was introduced through an inlet of the reactor and swept through the reactor to an outlet of the reactor to remove volatilized components from the reactor. The steam sweep gas was added at different flow rates and at either low vacuum (87 torr) or high vacuum (37 torr). Table 5 shows the RV, viscosity number (VN), and caprolactam concentration obtained at various times during SSP with the addition of a steam sweep at different pressures and different steam flow rates.

TABLE 5

| | Time | Temp. | Pressure | Steam Flow | Capro | | VN |
|---|---|---|---|---|---|---|---|
| Example | (hr) | (° C.) | (torr) | (mL/min) | (wt %) | RV | (mL/g) |
| Initial | 0 | 25 | Vacuum | 0 | 1.63 | 30 | 102.5 |
| 3 | 3.3 | 190 | 87 | 0.4 | 0.31 | 53 | 141.4 |
| 4 | 3 | 190 | 87 | 0.01 | 0.37 | 55 | 144.6 |
| 5 | 3 | 190 | 87 | 0.04 | 0.49 | 52 | 139.2 |
| 6 | 3 | 190 | 87 | 0.07 | 0.4 | 54 | 142.2 |
| 7 | 3 | 190 | 34 | 0.01 | 0.33 | 63 | 154.5 |
| 7 | 6 | 190 | 34 | 0.01 | 0.14 | 105 | 197 |
| 8 | 3 | 190 | 34 | 0.1 | 0.35 | 57 | 146.5 |
| 8 | 6 | 190 | 34 | 0.1 | 0.14 | 111 | 202 |

Examples 3-6 show the impact of the steam flow rate on the weight percent of caprolactam and RV. Each of Examples 3-6 had a caprolactam content of less than 0.49 wt % after only 3 hours of SSP, while the RV of polyamide solution ranged from 52 to 55. Surprisingly, at various steam flow rates, the steam addition greatly reduced the caprolactam content while controlling the RV of the polyamide. At a steam flow of 0.4 mL/min, the polyamide solution of Example 3 had 0.31 wt % of caprolactam and a RV of 53 after 3.3 hours of SSP. Even at low steam flow rates, Example 4 showed a caprolactam reduction of greater than 75% (from the initial caprolactam content) while maintaining the RV at 55.

Examples 7 and 8 show the residual caprolactam level and RV after 6 hours of SSP at steam flow rates of 0.01 mL/min and 0.1 mL/min, respectively. Examples 7 and 8 simultaneously achieved both low residual caprolactam level and a desirable RV, by utilizing steam addition during the SSP process. Unexpectedly, it was found that regardless of the steam flow rate, adding steam to the SSP process controlled the molecular weight building while removing caprolactam. After 6 hours of SSP, the residual caprolactam level of Examples 7 and 8 was less 0.2 wt % and the RV was less than 115. It can be seen that adding steam to the SSP process slows down molecular weight build, to provide sufficient time for residual caprolactam removal.

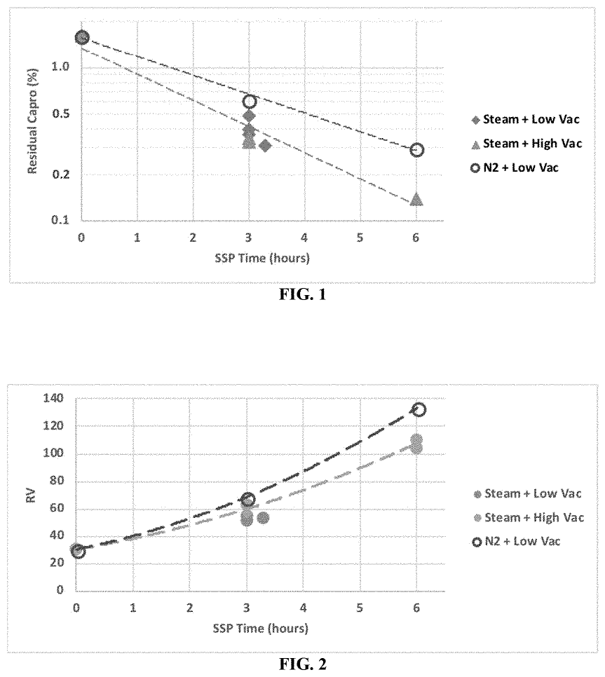

FIG. 1 shows the residual caprolactam content over 6 hours of SSP for Comparative Example C and Examples 3-8. Specifically, FIG. 1 shows a graph of the amount of residual caprolactam over 6 hours of SSP for Comparative Example C (nitrogen sweep at low vacuum), Example 3-6 (steam sweep at low vacuum), and Examples 7 and 8 (steam sweep at high vacuum). It can be seen that adding a steam sweep reduced residual caprolactam content below 0.2 wt % after 6 hours of SSP. Surprisingly, adding steam resulted in faster caprolactam removal than nitrogen, for a given SSP time.

FIG. 2 shows the RV of the polyamide solution over 6 hours of SSP for Comparative Example C and Examples 3-8. It can be seen that adding steam controls the SSP process to produce polymers with a desired molecular weight and low residual caprolactam monomer content. Surprisingly, adding a steam sweep during SSP yielded both faster caprolactam removal and lower RV, e.g., slower molecular weight build, compared to the nitrogen sweep, for a given SSP time.

### Examples 9-11

Examples 9-11 used the SSP process described above. In each of Examples 9-11, the polymer pellets were preconditioned with water prior to SSP. The Examples were tested at vacuum with the addition of steam to the SSP reactor. Table 6 shows the RV, viscosity number (VN), and caprolactam concentration obtained at various times during SSP for each example.

TABLE 6

| | | | | Polymer | Moisture | Steam Flow | HPLC Pump | | | |
|---|---|---|---|---|---|---|---|---|---|---|
| | Time | Temp. | Pressure | Pellet | of Pellet | Rate | Flow | Capro | | VN |
| Ex. | (hr) | (° C.) | (torr) | (g) | (wt %) | (mL/min) | (μL/min) | (wt %) | RV | (mL/g) |
| Initial | 0 | N/A | N/A | 11 | N/A | N/A | 0 | 1.63 | 31 | 103.4 |
| 9 | 3 | 190 | 87 | 11 | 12 | 0.05 | 50 | 0.8 | 50 | 136.3 |
| 9 | 6.5 | 190 | 87 | 11 | 12 | 0.05 | 50 | 0.26 | 80 | 174.1 |
| 10 | 3 | 190 | 87 | 11 | 12 | 0.09 | 100 | 0.48 | 49 | 135.3 |
| 10 | 6 | 190 | 87 | 11 | 12 | 0.09 | 100 | 0.05 | 131 | 218 |
| 11 | 3 | 190 | 87 | 11 | 12 | 0.02 | 10 | 1.01 | 52 | 140.4 |
| 11 | 6 | 190 | 87 | 11 | 12 | 0.02 | 10 | 0.24 | 78 | 171.4 |

Preconditioning the polymer pellets with water prior to SSP effectively reduced caprolactam concentration and controlled molecular weight build. At various steam flow rates, the moisture content in the polymer pellets used Examples 9-11 suppressed molecular weight build and considerably reduced caprolactam content after 6 hours of SSP. Surprisingly, preconditioning polymer pellets with water and adding steam during SSP worked in combination for efficient caprolactam removal and to slow down molecular weight build.

### Embodiments

The following embodiments are contemplated. All combinations of features and embodiments are contemplated.

Embodiment 1: A process for preparing polyamides having a low residual caprolactam content, the process comprising: (a) supplying a polyamide feedstock comprising caprolactam monomers to a solid state polymerization reactor; (b) initiating polymerization of the polyamide feedstock in the solid state polymerization reactor; and (c) adding water to the solid state polymerization reactor during polymerization to yield a high molecular weight polyamide solution comprising less than 0.6 wt % of residual caprolactam.

Embodiment 2: An embodiment of embodiment 1, wherein step (c) comprises adding a steam sweep gas to the solid state polymerization reactor.

Embodiment 3: An embodiment of embodiment 2, wherein the steam sweep gas is added to the solid state polymerization reactor under vacuum.

Embodiment 4: An embodiment of any of embodiments 2 or 3, wherein the steam sweep gas is added in combination with an inert sweep gas.

Embodiment 5: An embodiment of any of embodiments 1-4, wherein the high molecular weight polyamide solution comprises polyamides having a relative viscosity ranging from 60 to 300.

Embodiment 6: An embodiment of any of embodiments 1-5, wherein the high molecular weight polyamide solution comprises polyamides having a relative viscosity equal to or less than 130.

Embodiment 7: An embodiment of any of embodiments 1-6, wherein the polyamide feedstock undergoes solid state polymerization for less than 12 hours.

Embodiment 8: An embodiment of any of embodiments 1-7, wherein the polyamide feedstock undergoes polymerization in the solid state polymerization reactor for less than 12 hours, wherein the high molecular weight polyamide solution comprises less than 0.6 wt % of residual caprolactam, and wherein the high molecular weight polyamide solution comprises polyamides having a relative viscosity ranging from 60 to 300.

Embodiment 9: An embodiment of any of embodiments 1-8, wherein step (c) comprises adding a steam sweep gas to the solid state polymerization reactor, wherein the high molecular weight polyamide solution comprises less than 0.2 wt % of residual caprolactam, and wherein the high molecular weight polyamide solution comprises polyamides having a relative viscosity equal to or less than 130.

Embodiment 10: An embodiment of any of embodiments 1-9, wherein the polyamide feedstock comprises polymer pellets comprising water.

Embodiment 11: An embodiment of embodiment 10, wherein the polymer pellets comprise less than 25 wt % of water.

Embodiment 12: An embodiment of embodiments 10 or 11, wherein step (c) comprises releasing steam from the polymer pellets during polymerization in the solid state polymerization reactor.

Embodiment 13: A process for producing polyamides having a low residual caprolactam content, comprising: (a) supplying a polyamide feedstock comprising caprolactam monomers to a solid state polymerization reactor; (b) polymerizing the polyamide feedstock in the solid state polymerization reactor; and (c) adding a steam sweep gas to the solid state polymerization reactor during polymerization to yield a high molecular weight polyamide solution comprising less than 0.6 wt % of residual caprolactam.

Embodiment 14: An embodiment of embodiment 13, wherein a ratio of the flow rate of steam in grams per hour to the weight of the polymer pellets in grams ranges from 0.08:1 to 20:1.

Embodiment 15: An embodiment of embodiment 13, wherein the polyamide feedstock undergoes polymerization in the solid state polymerization reactor for less than 12 hours, wherein the high molecular weight polyamide solution comprises less than 0.6 wt % of residual caprolactam, and wherein the high molecular weight polyamide solution comprises polyamides having a relative viscosity ranging from 60 to 300.

Embodiment 16: An embodiment of embodiment 13, wherein the steam sweep gas is added to the polymerization reactor under vacuum during polymerization.

Embodiment 17: A process for producing polyamides having a low residual caprolactam content, comprising: (a) supplying a polyamide feedstock comprising caprolactam monomers to a solid state polymerization reactor, wherein the polyamide feedstock comprises polymer pellets comprising water; (b) polymerizing the polyamide feedstock in the solid state polymerization reactor; and (c) releasing steam from the polymer pellets during polymerization in the solid state polymerization reactor to yield a high molecular weight polyamide solution comprising less than 0.6 wt % of residual caprolactam.

Embodiment 18: An embodiment of embodiment 17, wherein the polymer pellets comprise less than 25 wt % of water.

Embodiment 19: An embodiment of embodiment 17, wherein the polymer pellets include sub-capsules that release water into the solid state polymerization reactor at different temperatures.

Embodiment 20: An embodiment of embodiment 17, wherein the polymer pellets release water into the solid state polymerization reactor at a controlled rate.

While the invention has been described in detail, modifications within the spirit and scope of the invention will be readily apparent to those of skill in the art. Such modifications are also to be considered as part of the present invention. In view of the foregoing discussion, relevant knowledge in the art and references discussed above in connection with the description of the related art and detailed description of embodiments, the disclosures of which are all incorporated herein by reference, further description is deemed unnecessary. In addition, it should be understood from the foregoing discussion that aspects of the invention and portions of various embodiments may be combined or interchanged either in whole or in part. Furthermore, those of ordinary skill in the art will appreciate that the foregoing description is by way of example only, and is not intended to limit the invention.

We claim:

1. A process for producing polyamides having a low residual caprolactam content, comprising:
(a) supplying a polyamide feedstock comprising caprolactam monomers to a solid state polymerization reactor;
(b) initiating polymerization of the polyamide feedstock in the solid state polymerization reactor; and
(c) adding water to the solid state polymerization reactor during polymerization to yield a high molecular weight polyamide solution comprising less than 0.6 wt % of residual caprolactam.

2. The process of claim 1, wherein step (c) comprises adding a steam sweep gas to the solid state polymerization reactor.

3. The process of claim 2, wherein the steam sweep gas is added to the solid state polymerization reactor under vacuum.

4. The process of claim 2, wherein the steam sweep gas is added in combination with an inert sweep gas.

5. The process of claim 1, wherein the high molecular weight polyamide solution comprises polyamides having a relative viscosity ranging from 60 to 300.

6. The process of claim 1, wherein the high molecular weight polyamide solution comprises polyamides having a relative viscosity equal to or less than 130.

7. The process of claim 1, wherein the polyamide feedstock undergoes solid state polymerization for less than 12 hours.

8. The process of claim 1, wherein the polyamide feedstock undergoes polymerization in the solid state polymerization reactor for less than 12 hours, wherein the high molecular weight polyamide solution comprises less than 0.6 wt % of residual caprolactam, and wherein the high molecular weight polyamide solution comprises polyamides having a relative viscosity ranging from 60 to 300.

9. The process of claim 1, wherein step (c) comprises adding a steam sweep gas to the solid state polymerization reactor, wherein the high molecular weight polyamide solution comprises less than 0.2 wt % of residual caprolactam, and wherein the high molecular weight polyamide solution comprises polyamides having a relative viscosity equal to or less than 130.

10. The process of claim 1, wherein the polyamide feedstock comprises polymer pellets comprising water.

11. The process of claim 10, wherein the polymer pellets comprise less than 25 wt % of water.

12. The process of claim 10, wherein step (c) comprises releasing steam from the polymer pellets during polymerization in the solid state polymerization reactor.

13. A process for producing polyamides having a low residual caprolactam content, comprising:
(a) supplying a polyamide feedstock comprising caprolactam monomers to a solid state polymerization reactor;
(b) polymerizing the polyamide feedstock in the solid state polymerization reactor; and
(c) adding a steam sweep gas to the solid state polymerization reactor during polymerization to yield a high molecular weight polyamide solution comprising less than 0.6 wt % of residual caprolactam.

14. The process of claim 13, wherein a ratio of the flow rate of steam in grams per hour to the weight of the polymer pellets in grams ranges from 0.08:1 to 20:1.

15. The process of claim 13, wherein the polyamide feedstock undergoes polymerization in the solid state polymerization reactor for less than 12 hours, wherein the high molecular weight polyamide solution comprises less than 0.6 wt % of residual caprolactam, and wherein the high molecular weight polyamide solution comprises polyamides having a relative viscosity ranging from 60 to 300.

16. The process of claim 13, wherein the steam sweep gas is added to the polymerization reactor under vacuum during polymerization.

17. A process for producing polyamides having a low residual caprolactam content, comprising:
(a) supplying a polyamide feedstock comprising caprolactam monomers to a solid state polymerization reactor, wherein the polyamide feedstock comprises polymer pellets comprising water;
(b) polymerizing the polyamide feedstock in the solid state polymerization reactor; and
(c) releasing steam from the polymer pellets during polymerization in the solid state polymerization reactor to yield a high molecular weight polyamide solution comprising less than 0.6 wt % of residual caprolactam.

18. The process of claim 17, wherein the polymer pellets comprise less than 25 wt % of water.

19. The process of claim 17, wherein the polymer pellets include sub-capsules that release water into the solid state polymerization reactor at different temperatures.

20. The process of claim 17, wherein the polymer pellets release water into the solid state polymerization reactor at a controlled rate.
